(19) United States
(12) Patent Application Publication
(10) Pub. No.: US 2010/0134375 A1
(43) Pub. Date: Jun. 3, 2010

(54) PLANAR ANTENNA

(75) Inventors: Yi-Ting CHEN, Taipei (TW); Yi-Fang Lin, Taipei (TW); Yang-Kai Wang, Taipei (TW); Ya-Ping Chen, Taipei (TW); Chia-Ling Liu, Taipei (TW); Hsin-Hong Wu, Taipei (TW)

Correspondence Address: LADAS & PARRY, 5670 WILSHIRE BOULEVARD, SUITE 2100, LOS ANGELES, CA, 90036-5679, US

(73) Assignee: ADVANCED CONNECTION TECHNOLOGY INC., Taipei (TW)

(21) Appl. No.: 12/327,698

(22) Filed: Dec. 3, 2008

(51) Int. Cl. H01Q 21/08

(52) U.S. Cl. 343/824

(57) ABSTRACT

A planar antenna includes: a substrate unit; a feeding line provided on the substrate unit and having first and second ends, a feeding point disposed between the first and second ends, and first and second feeding segments extending from the feeding point in opposite directions to the first and second ends, respectively, the lengths of the first and second feeding segments having a length difference that is approximately λ/2, where λ is the wavelength of an operating frequency of the planar antenna; a first radiating unit provided on the substrate unit and disposed adjacent to and spaced apart from the first feeding segment of the feeding line; a second radiating unit provided on the substrate unit and disposed adjacent to and spaced apart from the second feeding segment of the feeding line; and a grounding unit provided on the substrate unit for grounding.

### BACKGROUND OF THE INVENTION

1. Field of the Invention

The invention relates to a planar antenna, more particularly to a planar antenna including a feeding line having first and second feeding segments that have a length difference of approximately λ/2.

2. Description of the Related Art

With the ability in enhancing mobility and internet connectivity and data transmission for wireless communicating devices, such as cellular phones, PDA, notebook computers, etc., the Worldwide Interoperability for Microwave Access (WiMAX) standard has drawn the attentions of the electronic industry. The operating frequency bandwidth for WiMAX applications ranges from about 2 GHz to about 6 GHz, which is relatively broad. As such, the antenna to be used in WiMAX applications is required to have a broad operating frequency bandwidth, a high gain or a high directivity, and a small size.

### SUMMARY OF THE INVENTION

Therefore, an object of the present invention is to provide a planar antenna that has a broad operating bandwidth, a high gain, and a small size.

According to one aspect of the present invention, there is provided a planar antenna that comprises: a substrate unit; a feeding line provided on the substrate unit and having first and second ends, a feeding point disposed between the first and second ends, and first and second feeding segments extending from the feeding point in opposite directions to the first and second ends, respectively, the lengths of the first and second feeding segments having a length difference that is approximately λ/2, where λ is the wavelength of an operating frequency of the planar antenna; a first radiating unit provided on the substrate unit and disposed adjacent to and spaced apart from the first feeding segment of the feeding line; a second radiating unit provided on the substrate unit and disposed adjacent to and spaced apart from the second feeding segment of the feeding line; and a grounding unit provided on the substrate unit for grounding.

According to another aspect of the present invention, there is provided a planar antenna that comprises: a substrate unit including spaced apart upper and lower substrates and an insulator spacer sandwiched between the upper and lower substrates in such a manner to form an air gap between the upper and lower substrates, the upper substrate having an upper surface, the lower substrate having a lower surface; a feeding line provided on the upper surface of the upper substrate and having first and second ends, a feeding point disposed between the first and second ends, and first and second feeding segments extending from the feeding point in opposite directions to the first and second ends, respectively; a first radiating unit provided on the upper surface of the upper substrate and disposed adjacent to and spaced apart from the first feeding segment of the feeding line; a second radiating unit provided on the upper surface of the upper substrate and disposed adjacent to and spaced apart from the second feeding segment of the feeding line; and a grounding unit provided on the lower surface of the lower substrate for grounding.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic top view of the preferred embodiment of a planar antenna according to this invention;

FIG. 2 is a schematic side view of the preferred embodiment;

FIG. 3 is a schematic diagram to illustrate the current flows in first and second radiating units of the preferred embodiment at an operating frequency;

FIG. 4 is a schematic top view showing the dimensions of different portions of the preferred embodiment;

FIG. 5 is a schematic side view showing the dimensions of different portions of the preferred embodiment;

FIG. 6 is a plot of the return loss of the preferred embodiment;

FIG. 7 is a plot of the gain of the preferred embodiment;

FIG. 8 shows plots of radiation patterns of the preferred embodiment for x-y, x-z, and y-z planes when operated at 3.248 GHz;

FIG. 9 shows plots of radiation patterns of the preferred embodiment for x-y, x-z, and y-z planes when operated at 3.427 GHz; and

FIG. 10 shows plots of radiation patterns of the preferred embodiment for x-y, x-z, and y-z planes when operated at 3.607 GHz.

### DETAILED DESCRIPTION OF THE PREFERRED EMBODIMENT

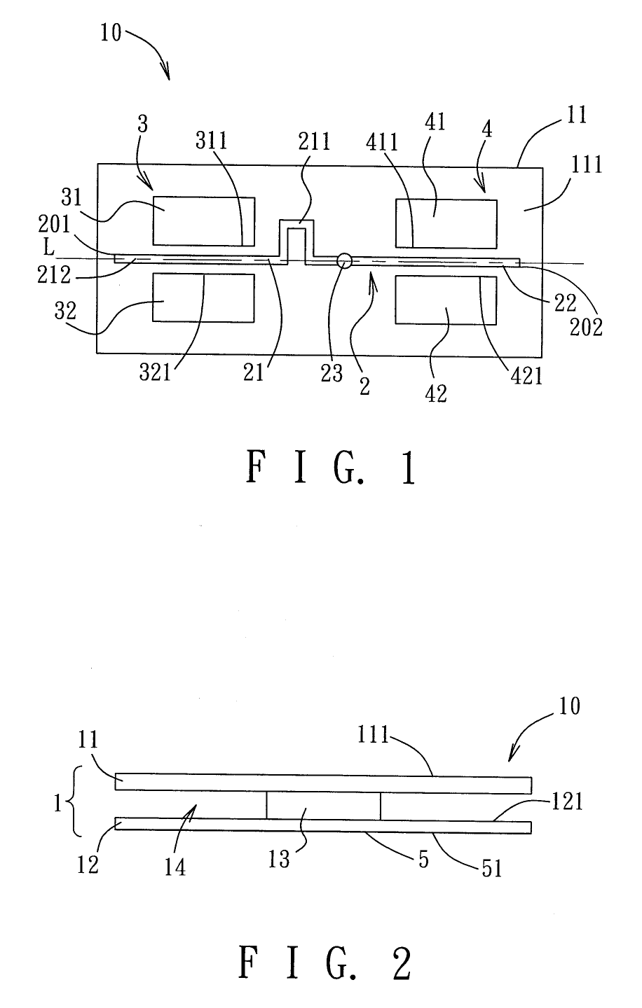

Referring to FIGS. 1 and 2, the preferred embodiment of a planar antenna 10 according to the present invention is shown to include: a substrate unit 1 including spaced apart plate-like upper and lower substrates 11, 12 and an insulator spacer 13 sandwiched between the upper and lower substrates 11, 12 in such a manner to form an air gap 14 between the upper and lower substrates 11, 12, the upper substrate 11 having an upper surface 111, the lower substrate 12 having a lower surface 121 parallel to the upper surface 111 of the upper substrate 11, the upper and lower substrates 11, 12 being parallel to each other; a feeding line 2 provided on the upper surface 111 of the upper substrate 11 and having first and second ends 201, 202, a feeding point 23 disposed between the first and second ends 201, 202, and first and second feeding segments 21, 22 extending from the feeding point 23 in opposite directions to the first and second ends 201, 202, respectively; a first radiating unit 3 provided on the upper surface 111 of the upper substrate 11 and disposed adjacent to and spaced apart from the first feeding segment 21 of the feeding line 2; a second radiating unit 4 provided on the upper surface 111 of the upper substrate 11 and disposed adjacent to and spaced apart from the second feeding segment 22 of the feeding line 2; and a grounding unit 5 provided on the lower surface 121 of the lower substrate 12 for grounding. The grounding unit 5 is a metal layer 51 formed on the lower surface 121 of the lower substrate 12. In addition to the grounding function, the metal layer 51 also provides another function of reflecting the radiated power of the first and second radiating units 3, 4 in a direction from the lower substrate 12 toward the upper substrate 11, thereby enhancing the gain of the planar antenna 10. In this embodiment, the upper and lower substrates 11, 12 are made from FR4 epoxy fiber glass, which has a dielectric constant of 4.4. With the formation of the air gap 14, which has a dielectric constant of 1, between the upper and lower substrates 11, 12, the overall dielectric constant of the substrate unit 1 can be lowered to approximately 2.7, thereby considerably increasing the operating frequency bandwidth of the planar antenna 10. The insulator spacer 13 employed in this preferred embodiment is made from polystyrene. Alternatively, the insulator spacer 13 can be made from other plastic materials.

In this embodiment, the second feeding segment 22 of the feeding line 2 is linear and the length thereof is shorter than that of the first feeding segment 21 of the feeding line 2. The first feeding segment 21 of the feeding line 2 has a bent portion 211 and a straight portion 212 extending from the bent portion 211 to the first end 201 of the feeding line 2. The lengths of the first and second feeding segments 21, 22 of the feeding line 2 have a length difference that is approximately λ/2, where λ is the wavelength of an operating frequency of the planar antenna 10, for enhancing the gain of the planar antenna 10. For instance, when the preferred embodiment is to be operated at a frequency bandwidth within a range of from 3.4 GHz to 3.6 GHz (i.e., a central frequency of 3.5 GHz), which is within the WiMAX bandwidth, the length difference is about 25 mm.

Preferably, the bent portion 211 of the first feeding segment 21 of the feeding line 2 is generally U-shaped. The design of the bent portion 211 is to increase the length of the first feeding segment 21 so as to achieve the length difference of λ/2 between the first and second feeding segments 21, 22. As such, the shape of the bent portion 211 is not limited to the aforesaid shape, and can be saw-like shape, S-shape, or wave-like shape.

In this embodiment, the first radiating unit 3 includes first and second radiating pieces 31, 32 that are respectively disposed at two opposite sides of the straight portion 212 of the first feeding segment 21 of the feeding line 2. The second radiating unit 4 includes third and fourth radiating pieces 41, 42 that are respectively disposed at two opposite sides of the second feeding segment 22 of the feeding line 2. The first, second, third and fourth radiating pieces 31, 32, 41, 42 are flat, have the same size, and are rectangular in shape. The first and second radiating pieces 31, 32 are symmetrical with respect to the straight portion 212 of the first feeding segment 21 of the feeding line 2. The third and fourth radiating pieces 41, 42 are symmetrical with respect to the second feeding segment 22 of the feeding line 2. Each of the first and second radiating pieces 31, 32 has one side 311 (321) disposed adjacent and parallel to the straight portion 212 of the first feeding segment 21 of the feeding line 2, thereby permitting coupling of the current signals between each of the first and second radiating pieces 31, 32 and the first feeding segment 21 of the feeding line 2. Each of the third and fourth radiating pieces 41, 42 has one side 411 (421) disposed adjacent and parallel to the second feeding segment 22 of the feeding line 2, thereby permitting coupling of the current signals between each of the third and fourth radiating pieces 41, 42 and the second feeding segment 22 of the feeding line 2.

In this embodiment, the straight portion 212 of the first feeding segment 21 of the feeding line 2 and the second feeding segment 22 of the feeding line 2 extend along an axis (L). The first and second radiating units 3, 4 are disposed at the same plane, and are line symmetrical to each other with respect to a line perpendicular to the axis (L).

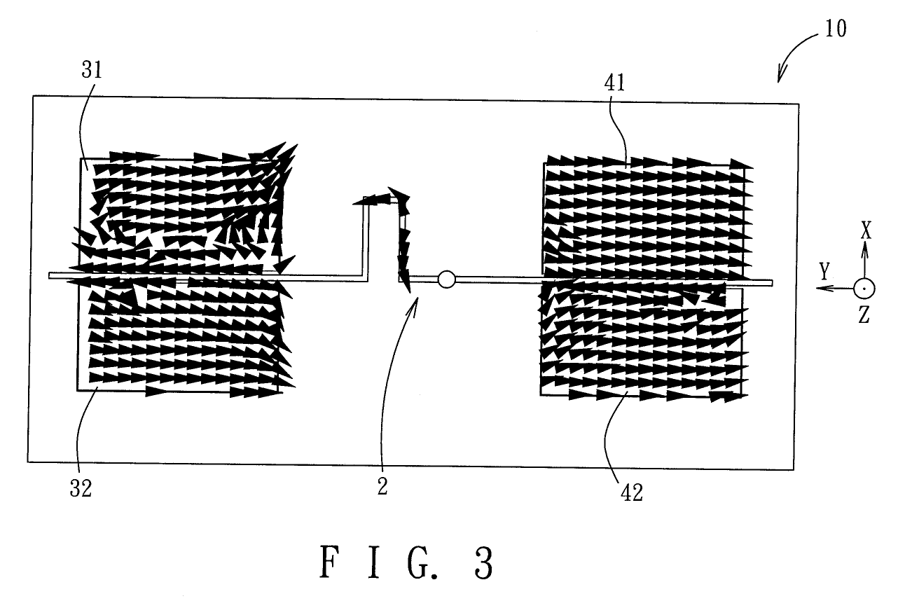

FIG. 3 shows current flow along the first and second feeding segments 21, 22 of the feeding line 2 and the first, second, third and fourth radiating pieces 31, 32, 41,42. If the lengths of the first and second feeding segments 21, 22 are substantially the same, a phase difference occurs between the current signals of the first and second radiating units 3, 4, which results in a destructive interference between the electromagnetic signals radiated by the first and second radiating units 3, 4 and thus a decrease in the gain of the planar antenna 10. However, as shown in FIG. 3, with a length difference of 25 mm between the first and second feeding segments 21, 22 of the feeding line 2, the aforesaid phase difference problem is eliminated, thereby generating a constructive interference between the electromagnetic signals radiated by the first and second radiating units 3, 4, and thereby enhancing the gain of the planar antenna 10.

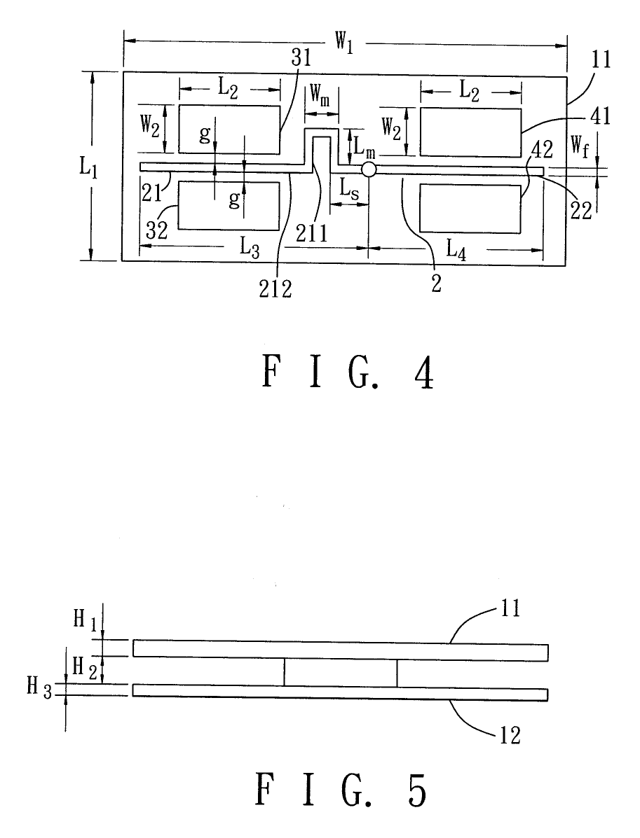

FIGS. 4 and 5 and Table 1 show the dimensions of different portions of the planar antenna 10.

TABLE 1
Dimensions of the antenna shown in FIGS. 4 and 5, mm

| W₁ | W₂ | Wₘ | W_{f} | L₁ | L₂ | L₃ | L₄ | Lₘ | Lₛ | H₁ | H₂ | H₃ | g |
|---|---|---|---|---|---|---|---|---|---|---|---|---|---|
| 100 | 15 | 5 | 0.7 | 50 | 26.6 | 52 | 42 | 10.35 | 6 | 1.6 | 3 | 0.4 | 0.45 |

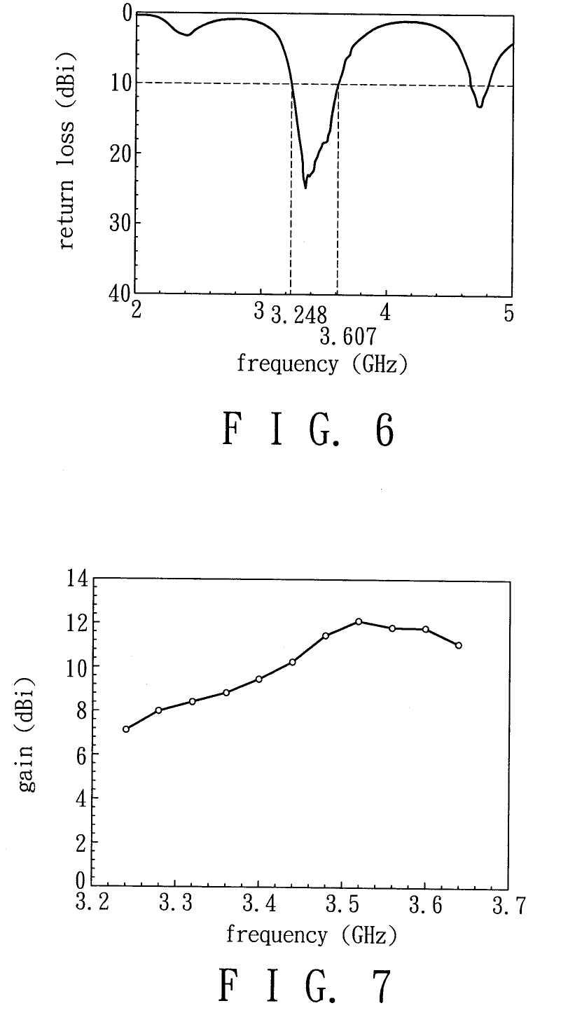

FIG. 6 shows the measured results of return loss over a frequency range for the planar antenna 10. The results show that the return loss is less than −10 dBi within a frequency range of from about 3.248 GHz to 3.607 GHz for the planar antennal 10, which covers the frequency bandwidth (3.4 GHz to 3.6 GHz) of Fixed Wireless Access (FWA) of the WiMAX standard.

FIG. 7 shows the measured results of the gain over a frequency range in a z-direction for the planar antenna 10. The results show that the gain of the planar antenna 10 is greater than 8 dBi within a frequency range of from about 3.4 GHz to 3.6 GHz, and is greater than 12 dBi at 3.52 GHz. Hence, the planar antenna 10 has a relatively high gain performance in the z-direction.

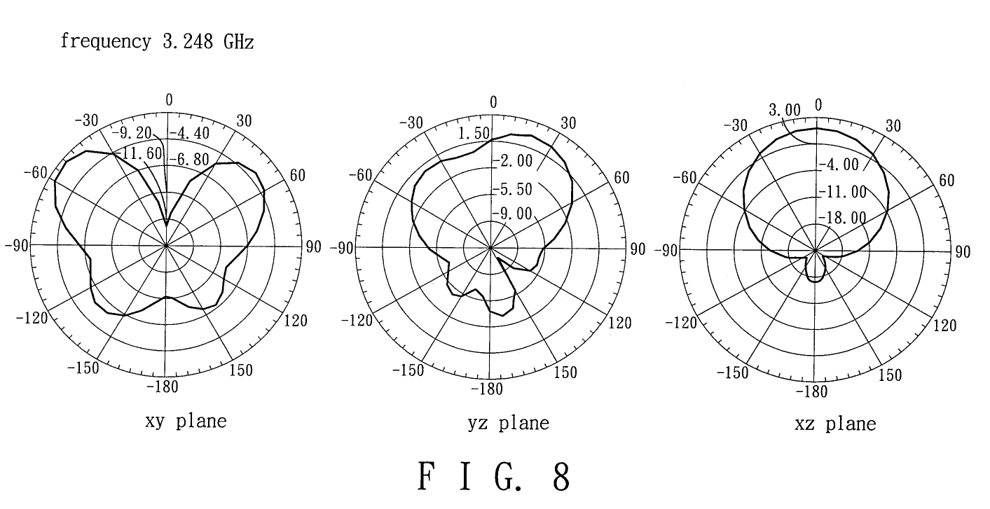

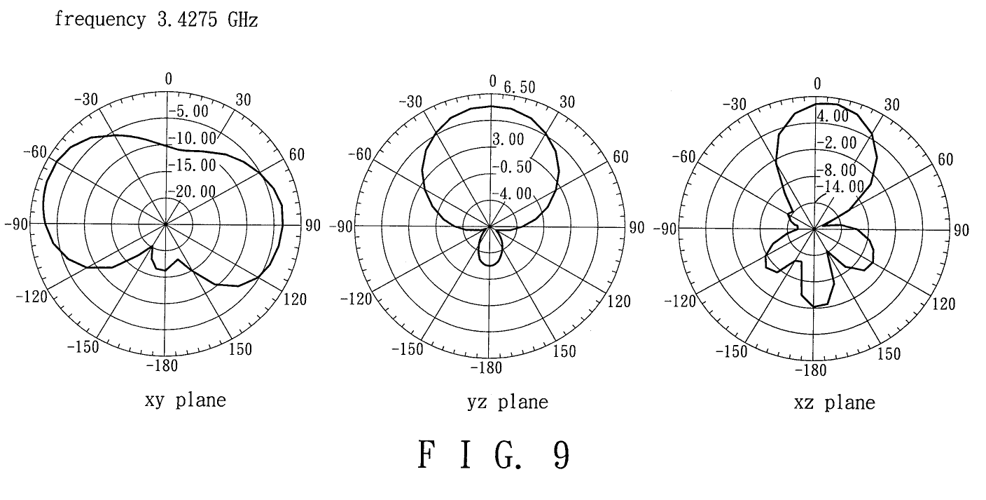

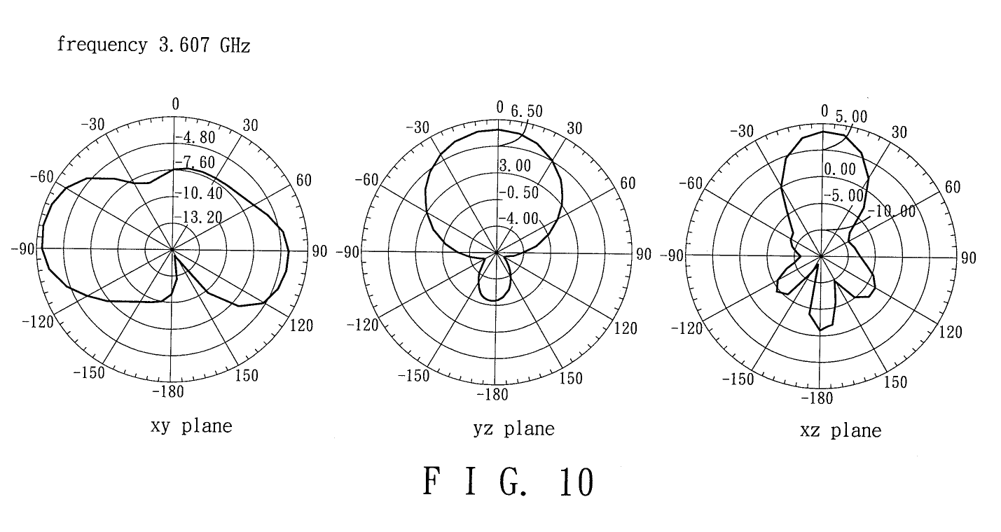

FIGS. 8 to 10 show the radiation patterns of the preferred embodiment for x-y, x-z, and y-z planes when operated at 3.248 GHz, 3.4275 GHz and 3.607 GHz, respectively.

By making the length difference between the first and second feeding segments 21, 22 of the feeding line 2 to be approximately λ/2, the orientations of the current flow in the first and second radiating units 3, 4 can be made similar, thereby generating a constructive interference between the electromagnetic signals radiated by the first and second radiating units 3, 4, and thereby increasing the gain of the planar antenna 10. Moreover, by forming the air gap 14 between the upper and lower substrates 11, 12, the overall dielectric constant of the substrate unit 1 can be lowered, thereby increasing the operating frequency bandwidth of the planar antenna 10.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A planar antenna comprising:
a substrate unit;
a feeding line provided on said substrate unit and having first and second ends, a feeding point disposed between said first and second ends, and first and second feeding segments extending from said feeding point in opposite directions to said first and second ends, respectively, the lengths of said first and second feeding segments having a length difference that is approximately λ/2, where λ is the wavelength of an operating frequency of said planar antenna;
a first radiating unit provided on said substrate unit and disposed adjacent to and spaced apart from said first feeding segment of said feeding line;
a second radiating unit provided on said substrate unit and disposed adjacent to and spaced apart from said second feeding segment of said feeding line; and
a grounding unit provided on said substrate unit for grounding.

2. The planar antenna of claim 1, wherein said second feeding segment of said feeding line is linear and the length thereof is shorter than that of said first feeding segment of said feeding line, said first feeding segment of said feeding line having a bent portion and a straight portion extending from said bent portion to said first end of said feeding line.

3. The planar antenna of claim 2, wherein said first radiating unit includes first and second radiating pieces that are respectively disposed at two opposite sides of said straight portion of said first feeding segment of said feeding line, each of said first and second radiating pieces having one side disposed adjacent and parallel to said straight portion of said first feeding segment of said feeding line so as to be coupled to said first feeding segment, said second radiating unit including third and fourth radiating pieces that are respectively disposed at two opposite sides of said second feeding segment of said feeding line, each of said third and fourth radiating pieces having one side disposed adjacent and parallel to said second feeding segment of said feeding line so as to be coupled to said second feeding segment.

4. The planar antenna of claim 3, wherein said first, second, third and fourth radiating pieces have the same size, and are rectangular in shape, said first and second radiating pieces being symmetrical with respect to said straight portion of said first feeding segment of said feeding line, said third and fourth radiating pieces being symmetrical with respect to said second feeding segment of said feeding line.

5. The planar antenna of claim 3, wherein said grounding unit is a metal layer formed on said substrate unit.

6. A planar antenna comprising:
a substrate unit including spaced apart upper and lower substrates and an insulator spacer sandwiched between said upper and lower substrates in such a manner to form an air gap between said upper and lower substrates, said upper substrate having an upper surface, said lower substrate having a lower surface;
a feeding line provided on said upper surface of said upper substrate and having first and second ends, a feeding point disposed between said first and second ends, and first and second feeding segments extending from said feeding point in opposite directions to said first and second ends, respectively;
a first radiating unit provided on said upper surface of said upper substrate and disposed adjacent to and spaced apart from said first feeding segment of said feeding line;
a second radiating unit provided on said upper surface of said upper substrate and disposed adjacent to and spaced apart from said second feeding segment of said feeding line; and
a grounding unit provided on said lower surface of said lower substrate for grounding.

7. The planar antenna of claim 6, wherein the lengths of said first and second feeding segments of said feeding line have a length difference that is approximately λ/2, where λ is the wavelength of an operating frequency of said planar antenna.

8. The planar antenna of claim 7, wherein said second feeding segment of said feeding line is linear and the length thereof is shorter than that of said first feeding segment of said feeding line, said first feeding segment of said feeding line having a bent portion and a straight portion extending from said bent portion to said first end of said feeding line.

9. The planar antenna of claim 8, wherein said first radiating unit includes first and second radiating pieces that are respectively disposed at two opposite sides of said straight portion of said first feeding segment of said feeding line, each of said first and second radiating pieces having one side disposed adjacent and parallel to said straight portion of said first feeding segment of said feeding line so as to be coupled to said first feeding segment, said second radiating unit including third and fourth radiating pieces that are respectively disposed at two opposite sides of said second feeding segment of said feeding line, each of said third and fourth radiating pieces having one side disposed adjacent and parallel to said second feeding segment of said feeding line so as to be coupled to said second feeding segment.

10. The planar antenna of claim 9, wherein said first, second, third and fourth radiating pieces have the same size, and are rectangular in shape, said first and second radiating pieces being symmetrical with respect to said straight portion of said first feeding segment of said feeding line, said third and fourth radiating pieces being symmetrical with respect to said second feeding segment of said feeding line.

11. The planar antenna of claim 9, wherein said grounding unit is a metal layer formed on said lower surface of said lower substrate.

12. The planar antenna of claim 8, wherein said straight portion of said first feeding segment of said feeding line and said second feeding segment of said feeding line extend along an axis.

13. The planar antenna of claim 8, wherein said bent portion is generally U-shaped.

14. The planar antenna of claim 10, wherein said first and second radiating units are line symmetrical to each other.
